(19) United States
(12) Patent Application Publication
(10) Pub. No.: US 2010/0180308 A1
(43) Pub. Date: Jul. 15, 2010

(54) METHOD AND APPARATUS FOR CONSUMING CONTENT

(75) Inventors: JERALD R. HOWCROFT, Beverly Hills, MI (US); Edward Walter, Boerne, TX (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., RENO, NV (US)

(21) Appl. No.: 12/352,964

(22) Filed: Jan. 13, 2009

(51) Int. Cl. H04N 5/445; G06F 17/30; G06F 3/00; G06Q 30/00; H04N 7/173

(52) U.S. Cl. 725/53; 715/716; 725/87; 707/E17.014; 705/26; 705/14.54

(57) ABSTRACT

A system that incorporates teachings of the present disclosure may include, for example, a controller to search a portal in response to a user query for a plurality of related content items of disparate formats accessible across a plurality of platforms, present search results and a graphical user interface for the consumption of the plurality of related content items of disparate formats from the single portal in response to the searching, and select a set of the plurality of related content items of disparate formats from the single portal for provisioning on a first device with a first disparate format and at least a second device with a second disparate format. Other embodiments are disclosed.

### FIELD OF THE DISCLOSURE

The present disclosure relates generally to content consumption techniques and more specifically to a method and apparatus for consuming content.

### BACKGROUND

There are many types of media devices today such as for example MP3 players, set-top boxes, and DVR recorders, just to mention a few, that can consume media content supplied by a content source. Similarly, there are many types of communication devices such as for example landline phones, mobile phones, and computers, some of which have a capability to consume media content. Typically, a user downloads media content to each of these devices from the same device that will consume the downloaded content.

### BRIEF DESCRIPTION OF THE DRAWINGS

FIG. 1 depicts an illustrative embodiment of a communication system;

FIG. 2 depicts an illustrative embodiment of a portal interacting with the communication system of FIG. 1;

FIG. 3 depicts an illustrative embodiment of a communication device utilized in the communication system of FIG. 1;

FIG. 4 depicts an illustrative embodiment of a method operating in portions of the communication system of FIG. 1; and

FIG. 5 is a diagrammatic representation of a machine in the form of a computer system within which a set of instructions, when executed, may cause the machine to perform any one or more of the methodologies discussed herein; and

FIG. 6 is diagrammatic representation of a system enabling content playback control across multiple access mediums in accordance with one or more embodiments herein.

### DETAILED DESCRIPTION

One embodiment of the present disclosure can entail a method in a single portal for searching in response to a user query for a plurality of related content items of disparate formats accessible across a plurality of platforms among interactive television (iTV) platforms, mobile phone platforms, and computer platforms via broadband access, presenting search results and a graphical user interface for the purchase of the plurality of related content items of disparate formats in response to the searching, and provisioning a selected set of the plurality of related content items of disparate formats, wherein at least one selected content item is in the form of Video on Demand that is accessible by the iTV platforms or the computer platforms and at least another selected content item is in the form of a digital music file or a ring tone file that is accessible by the mobile phone platform.

Another embodiment of the present disclosure can entail in a network element, a method involving initiating a search in response to a user query for a plurality of related content items of disparate formats accessible across a plurality of platforms, presenting search results and a graphical user interface operable to permit consumption of the plurality of related content items of disparate formats from the portal in response to the searching, and provisioning a selected set of the plurality of related content items of disparate formats identified to enable use of at least two of the plurality of platforms.

Yet another embodiment of the present disclosure can entail a computer-readable storage medium having computer instructions to present search results and a graphical user interface operable to consume a plurality of related content items of disparate formats in response to a search request for a plurality of related content items of disparate formats accessible across a plurality of platforms among iTV platforms, mobile phone platforms, and computer platforms via broadband internet access, and provision a selected set of the plurality of related content items of disparate formats.

Yet another embodiment of the present disclosure can entail a device having a controller to search a portal in response to a user query for a plurality of related content items of disparate formats accessible across a plurality of platforms, present search results and a graphical user interface for the consumption of the plurality of related content items of disparate formats from the portal in response to the searching, and select a set of the plurality of related content items of disparate formats from the portal for provisioning on a first device with a first disparate format and at least a second device with a second disparate format.

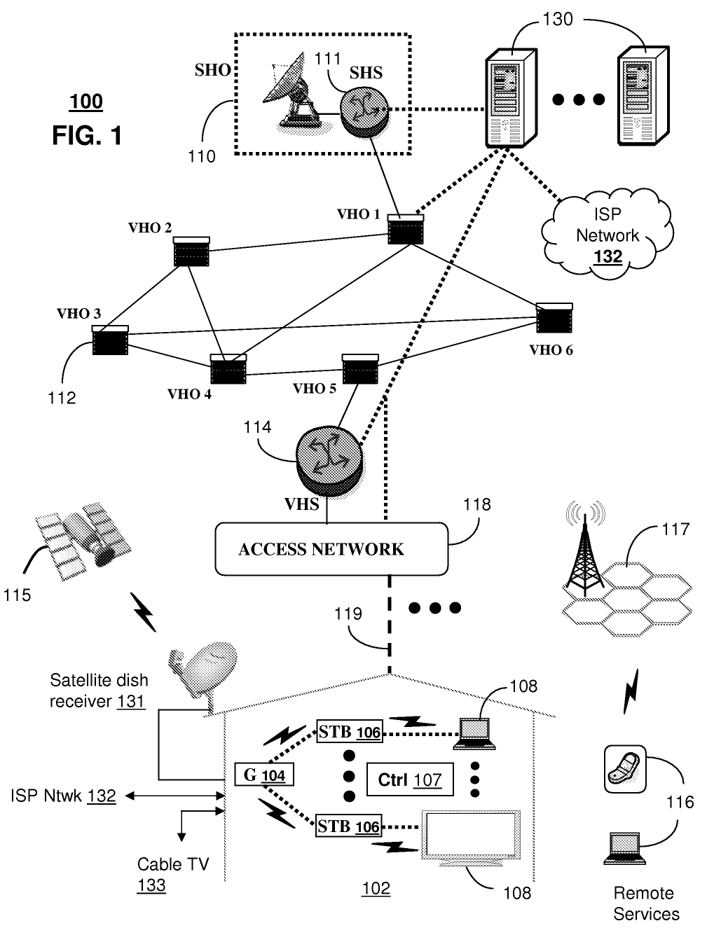

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

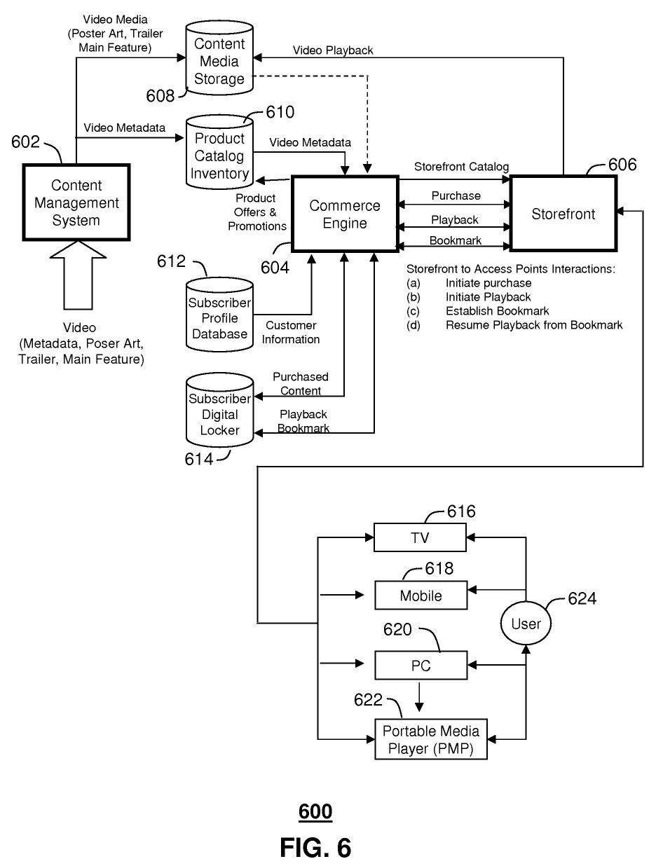

Another distinct portion of the computing devices 130 can function as a portal or server (herein referred to as server 130). The server 130 can use computing and communication technology to perform the function of providing a common portal or storefront to various access mediums as can be more clearly understood with reference to FIG. 6. The server 130 can include one or more servers providing managed access to content, subscriber data, and state information that can persist for use among the various access mediums in accordance with the embodiments herein.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive over-the-air or landline media content services.

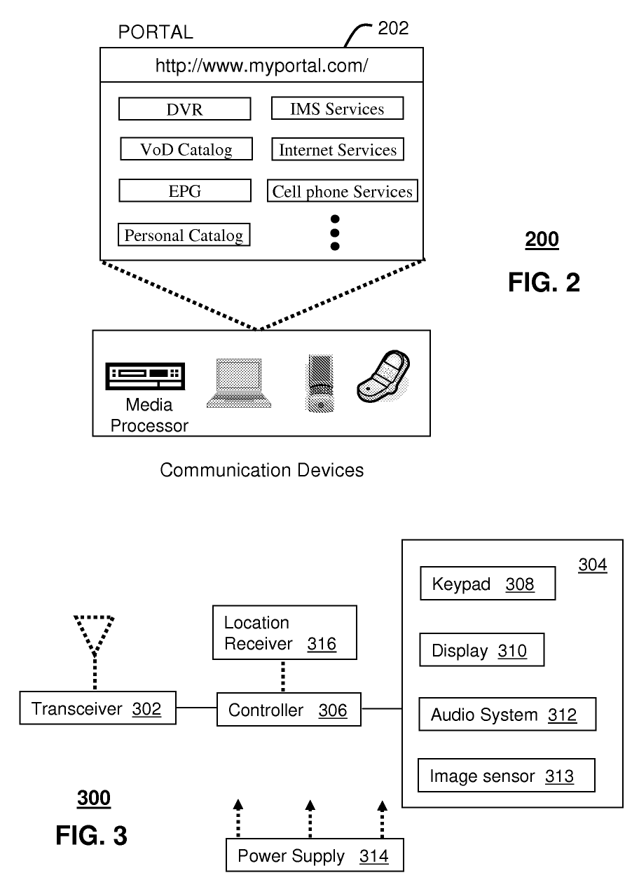

FIG. 2 depicts an illustrative embodiment of a portal 202 which can operate from the computing devices 130 described earlier of communication 100 illustrated in FIG. 1. The portal 202 can be used for managing services of communication systems 100-200. The portal 202 can be accessed by a Uniform Resource Locator (URL) with a common Internet browser such as Microsoft's Internet Explorer™ using an Internet-capable communication device such as those described for FIGS. 1-2. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

FIG. 3 depicts an exemplary embodiment of a communication device 300. Communication 300 can serve in whole or in part as an illustrative embodiment of the communication devices of FIGS. 1-2. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VolP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 412 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 100 based on signals generated by a constellation of GPS satellites, thereby facilitating common location services such as navigation.

The communication device 100 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 56 of FIG. 1. It will be appreciated that the communication device 300 can also represent other common devices that can operate in communication systems 100 of FIG. 1 such as a gaming console and a media player.

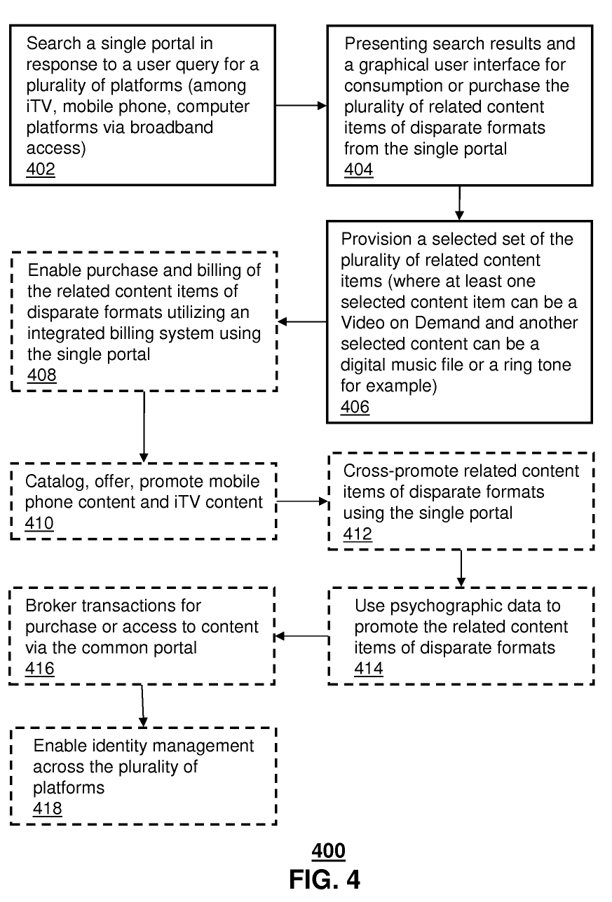

FIG. 4 depicts an illustrative method 400 that operates in portions of the communication system of FIG. 1. Method 400 can begin with 402 in which searching from a single portal is done in response to a user query for a plurality of related content items of disparate formats accessible across a plurality of platforms. The plurality of platforms for example can be among iTV platforms, mobile phone platforms, and computer platforms via broadband access. The method at 404 can present search results and a graphical user interface for the purchase of the plurality of related content items of disparate formats from the single portal in response to the searching and at 406 the method can provision a selected set of the plurality of related content items of disparate formats from the single portal. At least one selected content item can be in the form of Video on Demand (VoD) for example that is accessible by the iTV platforms or the computer platforms and at least another selected content item can be in the form of a digital music file or a ring tone file that is accessible by the mobile phone platform.

The single portal can enable the purchase and billing of the related content items of disparate formats utilizing an integrated billing system using the single portal at 408. The method at 410 can catalog, offer, and promote mobile phone content and iTV content and at 412 can cross-promote related content items of disparate formats using the single portal.

Psychographic data at 414 can be used to promote the related content items of disparate formats, wherein the psychographic data includes demographic information, pre-purchase activities, and purchase activities. A user profile can include demographic profiling information of a user, psychographic profiling information of the user, and/or user preferences supplied by the user. The demographic profiling information of the user can be based on age, gender, income, number of occupants in household, occupation, education, value of residential property, location of residential property, and/or fees paid for services rendered. The demographic profiling information of the user can be determined from a subscriber account of the user and/or monitored media consumption behavior of the user. One or more network elements of a communication system can utilize common demographic analysis tools to make these determinations. The psychographic profiling information of the user can also be determined from monitored media consumption behavior of the user and/or subscriber account information. Utilizing common psychographic analysis tools, one or more network elements of a communication system can generate the psychographic profiling information of the user. The psychographic profiling information can identify one or more traits, attitudes, interests, and/or lifestyles of the user to facilitate targeted content provisioning. The method 400 at 416 can also broker transactions for purchase of the plurality of related content items of disparate formats via the single portal whether the content comes from the service provider or a third party content provider. Further note that the system can also enable identity management across the plurality of platforms at 418.

Upon reviewing the aforementioned embodiments, it would be evident to an artisan with ordinary skill in the art that said embodiments can be modified, reduced, or enhanced without departing from the scope and spirit of the claims described below. For example, the access mediums or platforms are not limited to iTV, IPTV, personal computers, mobile communication devices, and portable media players, but can include almost any device or service capable of presenting digital data assuming the formatting between or across access mediums can be appropriately translated or modified to enable suitable display or other presentation. Furthermore, an order for the aforementioned steps in FIG. 4 should not necessarily be implied since the steps can be done in any number of different arrangements where the order is modified or where certain steps are omitted or where additional steps are further included.

Other suitable modifications can be applied to the present disclosure without departing from the scope of the claims below. Accordingly, the reader is directed to the claims section for a fuller understanding of the breadth and scope of the present disclosure.

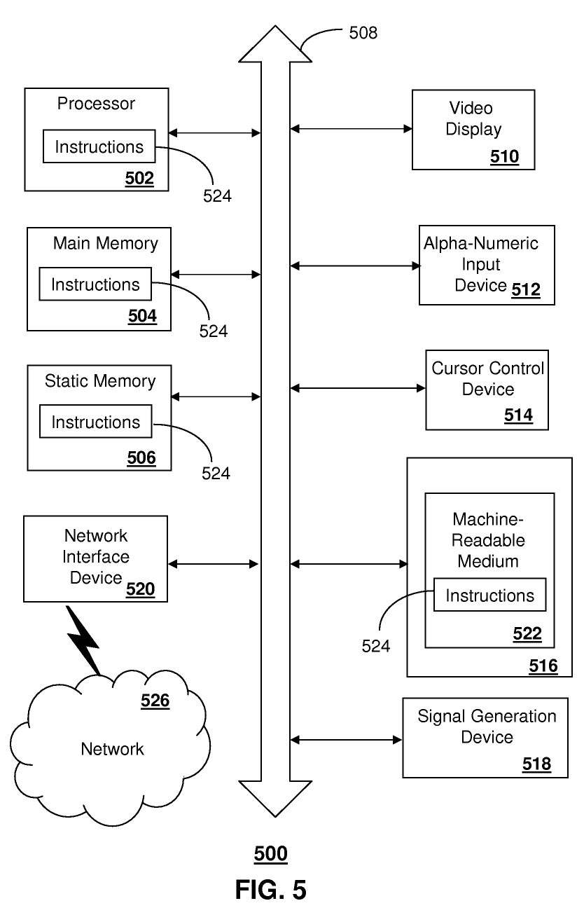

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Referring to FIG. 6, a system 600 is illustrated that presents a particular embodiment control of content from multiple access mediums such as “3-screen applications” that can include televisions, mobile devices (e.g., cellular phones, personal digital assistants) and computers (e.g., laptops and desktop computers). Such a system can offer content (e.g., video-on-demand (VoD), Over-the-Top streaming video, Download & Play video, etc.) to be consumable across multiple access mediums, including the TV 616, a broadband portal 620, mobile/cell phone device 618 and Portable Media Players (PMPs) 622. Such content can be browsed, sampled and purchased from a common portal or Storefront 606.

The purchased or requested content can be consumable (playback-enabled) across the multiple access mediums as requested by a user 624. For example, the user 624 can pause the playback of purchased or requested content in one access medium (for example, broadband TV) and establish a bookmark. The user 624 can then be able to resume the content playback on any other access medium (for example, mobile phone, PC or PMP) from the pre-established bookmark. Similarly, content that is available across various platforms can be searched and retrieved using a single portal or storefront 606 and provisioned (or purchased or consumed) across a plurality of disparate platforms or screen applications on different devices. For example, a single search can retrieve content for a movie available for VoD on a computer or iTV device as well as content in the form of music or ringtone for a mobile device. From the same portal 606, the different content formats (such as VoD and ring tone) can be selected and also provisioned to the different devices that have disparate platforms.

Such a system or architecture for control across access mediums can include a Content Management System 602, which discovers, acquires, ingests, formats and encodes raw content, Content Media Storage 608, which stores all media files associated with the content, including any poster art, trailer and main feature media files, a centralized Product Catalog 610, which maintains an inventory of all offerable content and any associated offers or promotions, and a Subscriber Database 612 which contains customer information, including service profiles and geographic location. The system 600 can further include a Subscriber Digital Locker 614 which tracks customers' access rights for specific content (such as purchased, free, gifted content) and a Commerce Engine 604 coupled to the Storefront 606 which maintains the Storefront content and customers' rights to the content. The Storefront 606 can include a Storefront application which brokers interactions to each of the Storefront access mediums (616-622). Further details of the components are described below.

The Content Management System 602 acquires and ingests content and then formats the content into an appropriate consumption platform and encodes the content if necessary. The Content Media Storage 608 centrally stores content such as content poster art images, a trailer and main feature media files where it is distributed to the user's access medium (PC, TV, mobile/cell phone device). The Product Catalog/Inventory 610 can include metadata for all ingested content that is centrally stored in a common Product Catalog where it can be made into sellable units and monetized via the commerce engine 604. The Subscriber Profile Database 612 can be a central storage that can include all customer information needed to manage content rights for subscribers. Information on the customer's service profile, geographic and demographic information can be persisted. The Subscriber Digital Locker 614 can include all content that a specific customer has access to (such as purchased content, gifted content, uploaded content, free content) and specific associated customer content information can be stored in the Subscriber Digital Locker as well. It is in the Digital Locker where the customer's content across the multiple access mediums can be persisted.

The Commerce Engine 604 enables service providers to create publishable Storefront content by taking ingested content information and transforming them into sellable units (definitions of bundles, offers, promotions). The Commerce Engine 604 publishes the Storefront inventory to the Storefront application 606 where the user 624 can access it via the multiple access mediums (PC, TV, mobile device, PMP). The Commerce Engine 604 can also broker user transactions via the Storefront 606 (by enabling the browsing of the catalog, enabling purchase requests, etc.). The Storefront 606 can be an eCommerce application that enables the access of content for browsing, sampling, purchasing and consumption via the “3-screen” or multiple access mediums. The embodiments herein enable ingested content to be accessible via the multiple access mediums and enable the coordination of access controls across all the access mediums.

The Storefront or portal can be a content offer application that utilizes billing systems, customer authentication systems (such as iGate) and an IPTV Storefront Client (deployed as a browser application for the TV platform) to provide a user-friendly method to present, review, and purchase cross-platform products and services. As contemplated, the portal can be accessed from a PC or an IPTV system in order to order and view content. The portal can also enabled so that it can be accessed from a Mobile device using WAP or other wireless access protocols and browsers.

A consolidated portal or storefront for content can provide for cataloging, presentation and commerce, accessible across multiple channels (IPTV, web, mobile), for direct access to assets across a portfolio services such as IPTV services in the form of VoDs, PPVs and mobile services such as music, ring tones, ring-back tones.

The embodiments herein can support a system or device that enables a wide variety of content across platforms or presentation applications. The portal can enable the ability to support search functionalities of the asset inventory based on various search criteria and can also authenticate customers across platforms. Browsing, Purchasing and Consumption of mobile assets or other assets whether available from the carrier or a third party can be integrated and inventoried by such a system. The system can also provide support for both online/electronic and printed coupons or provide recommendations for assets based on psychographic data as explained above or otherwise. The system herein can also include an integrated billing system for all storefront provisioned content, including taxation and can also restrict assets or offers or promotions based on Family-friendly filtration.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. In a single portal, a method, comprising:
searching in response to a user query for a plurality of related content items of disparate formats accessible across a plurality of platforms among interactive television (iTV) platforms, mobile phone platforms, and computer platforms via broadband access;
presenting search results and a graphical user interface for the purchase of the plurality of related content items of disparate formats in response to the searching; and
provisioning a selected set of the plurality of related content items of disparate formats, wherein at least one selected content item is in the form of Video on Demand that is accessible by the iTV platforms or the computer platforms and at least another selected content item is in the form of a digital music file or a ring tone file that is accessible by the mobile phone platform.

2. The method of claim 1, wherein the single portal enables the purchase and billing of the related content items of disparate formats utilizing an integrated billing system.

3. The method of claim 1, wherein the method catalogs, offers, and promotes mobile phone content and iTV content.

4. The method of claim 1, wherein the method cross-promotes related content items of disparate formats.

5. The method of claim 1, wherein the method uses psychographic data to promote the related content items of disparate formats, wherein the psychographic data includes demographic information, pre-purchase activities, and purchase activities.

6. The method of claim 1, wherein the iTV application operates in one of an Internet Protocol TV system, a cable TV system, and a satellite TV system.

7. The method of claim 1, comprising brokering transactions for purchase of the plurality of related content items of disparate formats via the single portal.

8. In a network element, a method, comprising:
initiating a search in response to a user query for a plurality of related content items of disparate formats accessible across a plurality of platforms;
presenting search results and a graphical user interface operable to permit consumption of the plurality of related content items of disparate formats from the portal in response to the searching; and
provisioning a selected set of the plurality of related content items of disparate formats identified to enable use of at least two of the plurality of platforms.

9. The method of claim 8, wherein at least one selected content item is in the form of Video on Demand that is accessible by iTV platforms or computer platforms and at least another selected content item is in the form of a digital music file or a ring tone file that is accessible by a mobile phone platform.

10. The method of claim 8, wherein the plurality of platforms are among iTV platforms, mobile phone platforms, and computer platforms via broadband internet access.

11. The method of claim 10, wherein the iTV platforms operate in one of an Internet Protocol TV system, a cable TV system, and a satellite TV system.

12. The method of claim 8, wherein the method enables identity management across the plurality of platforms.

13. A computer-readable storage medium operating in a portal, comprising computer instructions to:
present search results and a graphical user interface operable to consume a plurality of related content items of disparate formats 1 in response to a search request for a plurality of related content items of disparate formats accessible across a plurality of platforms among interactive television (iTV) platforms, mobile phone platforms, and computer platforms via broadband internet access; and
provision a selected set of the plurality of related content items of disparate formats.

14. The computer-readable storage medium of claim 13, wherein at least one selected content item is in the form of Video on Demand that is accessible by the iTV platforms or the computer platforms and at least another selected content item is in the form of a digital music file or a ring tone file that is accessible by the mobile phone platform.

15. The computer-readable storage of claim 13, comprising computer instructions to enable the purchase and billing of the related content items of disparate formats utilizing an integrated billing system.

16. The computer-readable storage of claim 13, comprising computer instructions to cross-promote related content items of disparate formats.

17. The computer-readable storage of claim 13, comprising computer instructions to broker transactions for purchase of the plurality of related content items of disparate formats.

18. A device, comprising a controller to:
search a portal in response to a user query for a plurality of related content items of disparate formats accessible across a plurality of platforms;
present search results and a graphical user interface for the consumption of the plurality of related content items of disparate formats from the single portal in response to the searching; and
select a set of the plurality of related content items of disparate formats from the single portal for provisioning on a first device with a first disparate format and at least a second device with a second disparate format.

19. The device of claim 18, wherein the first device is the device.

20. The device of claim 18, wherein the device or the first device is a computer having broadband access or an interactive television (iTV) device and the second device is a mobile phone.

21. The device of claim 18, wherein the controller is adapted to select content from a server having a product catalog which maintains an inventory of offerable media content and associated promotions.

22. The device of claim 18, wherein at least one selected content item is in the form of Video on Demand that is accessible by iTV platforms or computer platforms and at least another selected content item is in the form of a digital music file or a ring tone file that is accessible by a mobile phone platform.

23. The device of claim 18, wherein the plurality of platforms are among iTV platforms, mobile phone platforms, and computer platforms via broadband internet access.

24. The device of claim 18, wherein the controller is operable to provide identity management across the plurality of platforms.

25. The device of claim 18, wherein the device corresponds to one of a mobile phone, a computer, and a set-top box.
